(19) United States
(12) Patent Application Publication
(10) Pub. No.: US 2022/0143587 A1
(43) Pub. Date: May 12, 2022

(54) HIGH NANOPORE VOLUME CATALYST AND PROCESS USING SSZ-91

(71) Applicant: CHEVRON U.S.A INC., San Ramon, CA (US)

(72) Inventors: Yihua ZHANG, Albany, CA (US); Adeola Florence OJO, Pleasant Hill, CA (US); Guan-Dao LEI, Walnut Creek, CA (US)

(21) Appl. No.: 17/095,010

(22) Filed: Nov. 11, 2020

(51) Int. Cl. B01J 29/74; B01J 29/70; B01J 29/80; B01J 21/04; B01J 35/10; C10M 109/02; C10G 45/64

(52) U.S. Cl. CPC B01J 29/74; B01J 29/703; B01J 29/7023; B01J 29/80; B01J 21/04; B01J 2029/062; B01J 35/1042; B01J 35/1047; B01J 35/1061; C10M 109/02; C10G 45/64; B01J 35/1038

(57) ABSTRACT

An improved hydroisomerization catalyst and process for making a base oil product wherein the catalyst comprises a base extrudate that includes SSZ-91 molecular sieve and a high nanopore volume alumina. The catalyst and process generally involves the use of a SSZ-91/high nanopore volume alumina based catalyst to produce dewaxed base oil products by contacting the catalyst with a hydrocarbon feedstock. The catalyst base extrudate advantageously comprises an alumina having a pore volume in the 11-20 nm pore diameter range of 0.05 to 1.0 cc/g, with the base extrudate formed from SSZ-91 and the alumina having a total pore volume in the 2-50 nm pore diameter range of 0.12 to 1.80 cc/g. The catalyst and process provide improved base oil yield with reduced gas and fuels production.

### FIELD OF THE INVENTION

A hydroisomerization catalyst and process for producing base oils from hydrocarbon feedstocks using a catalyst comprising a base extrudate of SSZ-91 molecular sieve and high nanopore volume alumina.

### BACKGROUND OF THE INVENTION

A hydroisomerization catalytic dewaxing process for the production of base oils from a hydrocarbon feedstock involves introducing the feed into a reactor containing a dewaxing catalyst system with the presence of hydrogen. Within the reactor, the feed contacts the hydroisomerization catalyst under hydroisomerization dewaxing conditions to provide an isomerized stream. Hydroisomerization removes aromatics and residual nitrogen and sulfur and isomerize the normal paraffins to improve the cold flow properties. The isomerized stream may be further contacted in a second reactor with a hydrofinishing catalyst to remove traces of any aromatics, olefins, improve color, and the like from the base oil product. The hydrofinishing unit may include a hydrofinishing catalyst comprising an alumina support and a noble metal, typically palladium, or platinum in combination with palladium.

The challenges generally faced in typical hydroisomerization catalytic dewaxing processes include, among others, providing product(s) that meet pertinent product specifications, such as cloud point, pour point, viscosity and/or viscosity index limits for one or more products, while also maintaining good product yield. In addition, further upgrading, e.g., during hydrofinishing, to further improve product quality may be used, e.g., for color and oxidation stability by saturating aromatics to reduce the aromatics content. The presence of residual organic sulfur and nitrogen from upstream hydrotreatment and hydrocracking processes, however, may have a significant impact on downstream processes and final base oil product quality.

Dewaxing of straight chain paraffins involves a number of hydroconversion reactions, including hydroisomerization, redistribution of branches, and secondary hydroisomerization. Consecutive hydroisomerization reactions lead to an increased degree of branching accompanied by a redistribution of branches. Increased branching generally increases the probability of chain cracking, leading to greater fuels yield and a loss of base oil/lube yield. Minimizing such reactions, including the formation of hydroisomerization transition species, can therefore lead to increased base oil/lube yield.

A more robust catalyst for base oil/lube production is therefore needed to isomerize wax molecules and provide increased base oil/lube yield by reducing undesired cracking and hydroisomerization reactions. Accordingly, a continuing need exists for catalysts and processes to produce base oil/lube products having reduced fuels production, while also providing good base oil/lube product yield.

### SUMMARY OF THE INVENTION

This invention relates to a hydroisomerization catalyst and process for converting wax-containing hydrocarbon feedstocks into high-grade products, including base or lube oils generally having an increased yield of base oil product. Such processes employ a catalyst system comprising a base extrudate formed from a mixture of SSZ-91 molecular sieve and a high nanopore volume (HNPV) alumina. The hydroisomerization process converts aliphatic, unbranched paraffinic hydrocarbons (n-paraffins) to isoparaffins and cyclic species, thereby decreasing the pour point and cloud point of the base oil product as compared with the feedstock. Catalysts formed from a base extrudate of SSZ-91/HNPV alumina have been found to advantageously provide base oil products having an increased base oil/lube product yield as compared with base oil products produced using other catalysts.

In one aspect, the present invention is directed to a hydroisomerization catalyst and process, which are useful to make dewaxed products including base oils, particularly base oil products of one or more product grades through hydroprocessing of a suitable hydrocarbon feedstream. While not necessarily limited thereto, one of the goals of the invention is to provide increased base oil product yield while also reducing the production of gas and fuels grade products.

The catalyst generally comprises a base extrudate comprising an SSZ-91 molecular sieve and an HNPV alumina, wherein the alumina has a pore volume in the 11-20 nm pore diameter range of 0.05 to 1.0 cc/g and the base extrudate has a total pore volume in the 2-50 nm pore diameter range of 0.12 to 1.80 cc/g, and at least one modifier selected from Groups 6 to 10 and Group 14 of the Periodic Table.

The process generally comprises contacting a hydrocarbon feed with the hydroisomerization catalyst under hydroisomerization conditions to produce a product or product stream. The hydroisomerization catalyst comprises an SSZ-91 molecular sieve and an HNPV alumina, wherein the alumina has a pore volume in the 11-20 nm pore diameter range of 0.05 to 1.0 cc/g and the base extrudate has a total pore volume in the 2-50 nm pore diameter range of 0.12 to 1.80 cc/g, and at least one modifier selected from Groups 6 to 10 and Group 14 of the Periodic Table.

### DETAILED DESCRIPTION

Although illustrative embodiments of one or more aspects are provided herein, the disclosed processes may be implemented using any number of techniques. The disclosure is not limited to the illustrative or specific embodiments, drawings, and techniques illustrated herein, including any exemplary designs and embodiments illustrated and described herein, and may be modified within the scope of the appended claims along with their full scope of equivalents.

Unless otherwise indicated, the following terms, terminology, and definitions are applicable to this disclosure. If a term is used in this disclosure but is not specifically defined herein, the definition from the IUPAC Compendium of Chemical Terminology, 2nd ed (1997), may be applied, provided that definition does not conflict with any other disclosure or definition applied herein, or render indefinite or non-enabled any claim to which that definition is applied. To the extent that any definition or usage provided by any document incorporated herein by reference conflicts with the definition or usage provided herein, the definition or usage provided herein is to be understood to apply.

“API gravity” refers to the gravity of a petroleum feedstock or product relative to water, as determined by ASTM D4052-11.

“Viscosity index” (VI) represents the temperature dependency of a lubricant, as determined by ASTM D2270-10(E2011).

“Vacuum gas oil” (VGO) is a byproduct of crude oil vacuum distillation that can be sent to a hydroprocessing unit or to an aromatic extraction for upgrading into base oils. VGO generally comprises hydrocarbons with a boiling range distribution between 343° C. (649° F.) and 593° C. (1100° F.) at 0.101 MPa.

“Treatment,” “treated,” “upgrade,” “upgrading” and “upgraded,” when used in conjunction with an oil feedstock, describes a feedstock that is being or has been subjected to hydroprocessing, or a resulting material or crude product, having a reduction in the molecular weight of the feedstock, a reduction in the boiling point range of the feedstock, a reduction in the concentration of asphaltenes, a reduction in the concentration of hydrocarbon free radicals, and/or a reduction in the quantity of impurities, such as sulfur, nitrogen, oxygen, halides, and metals.

“Hydroprocessing” refers to a process in which a carbonaceous feedstock is brought into contact with hydrogen and a catalyst, at a higher temperature and pressure, for the purpose of removing undesirable impurities and/or converting the feedstock to a desired product. Examples of hydroprocessing processes include hydrocracking, hydrotreating, catalytic dewaxing, and hydrofinishing.

“Hydrocracking” refers to a process in which hydrogenation and dehydrogenation accompanies the cracking/fragmentation of hydrocarbons, e.g., converting heavier hydrocarbons into lighter hydrocarbons, or converting aromatics and/or cycloparaffins (naphthenes) into non-cyclic branched paraffins.

“Hydrotreating” refers to a process that converts sulfur and/or nitrogen-containing hydrocarbon feeds into hydrocarbon products with reduced sulfur and/or nitrogen content, typically in conjunction with hydrocracking, and which generates hydrogen sulfide and/or ammonia (respectively) as byproducts. Such processes or steps performed in the presence of hydrogen include hydrodesulfurization, hydrodenitrogenation, hydrodemetallation, and/or hydrodearomatization of components (e.g., impurities) of a hydrocarbon feedstock, and/or for the hydrogenation of unsaturated compounds in the feedstock. Depending on the type of hydrotreating and the reaction conditions, products of hydrotreating processes may have improved viscosities, viscosity indices, saturates content, low temperature properties, volatilities and depolarization, for example. The terms “guard layer” and “guard bed” may be used herein synonymously and interchangeably to refer to a hydrotreating catalyst or hydrotreating catalyst layer. The guard layer may be a component of a catalyst system for hydrocarbon dewaxing, and may be disposed upstream from at least one hydroisomerization catalyst.

“Catalytic dewaxing”, or hydroisomerization, refers to a process in which normal paraffins are isomerized to their more branched counterparts by contact with a catalyst in the presence of hydrogen.

“Hydrofinishing” refers to a process that is intended to improve the oxidation stability, UV stability, and appearance of the hydrofinished product by removing traces of aromatics, olefins, color bodies, and solvents. UV stability refers to the stability of the hydrocarbon being tested when exposed to UV light and oxygen. Instability is indicated when a visible precipitate forms, usually seen as Hoc or cloudiness, or a darker color develops upon exposure to ultraviolet light and air. A general description of hydrofinishing may be found in U.S. Pat. Nos. 3,852,207 and 4,673,487.

The term “Hydrogen” or “hydrogen” refers to hydrogen itself, and/or a compound or compounds that provide a source of hydrogen.

“BET surface area” is determined by N₂ adsorption at its boiling temperature. BET surface area is calculated by the 5-point method at P/P₀=0.050, 0.088, 0.125, 0.163, and 0.200. Samples are first pre-treated at 400° C. for 6 hours in the presence of flowing, dry N₂ to eliminate any adsorbed volatiles, e.g., water or organics.

“Cut point” refers to the temperature on a True Boiling Point (TBP) curve at which a predetermined degree of separation is reached.

“Pour point” refers to the temperature at which an oil will begin to flow under controlled conditions. The pour point may be determined by, for example, ASTM D5950.

“Cloud point” refers to the temperature at which a lube base oil sample begins to develop a haze as the oil is cooled under specified conditions. The cloud point of a lube base oil is complementary to its pour point. Cloud point may be determined by, for example, ASTM D5773.

“Nanopore diameter” and “Nanopore volume” are determined by N₂ adsorption at its boiling temperature and calculated from N₂ isotherms by the BJH method described in E. P. Barrett, L. G. Joyner and P. P. Halenda, “The determination of pore volume and area distributions in porous substances. I. Computations from nitrogen isotherms.” J. Am. Chem. Soc. 73, 373-380, 1951. Samples are first pre-treated at 400° C. for 6 hours in the presence of flowing, dry N₂ to eliminate any adsorbed volatiles, e.g., water or organics. Pore diameters at 10%, 50% and 90% of the total nanopore volume, referred to as d₁₀, d₅₀, and d₉₀, respectively, may also be determined from such N₂ adsorption measurements.

“TBP” refers to the boiling point of a hydrocarbonaceous feed or product, as determined by Simulated Distillation (SimDist) by ASTM D2887-13.

“Hydrocarbonaceous”, “hydrocarbon” and similar terms refer to a compound containing only carbon and hydrogen atoms. Other identifiers may be used to indicate the presence of particular groups, if any, in the hydrocarbon (e.g., halogenated hydrocarbon indicates the presence of one or more halogen atoms replacing an equivalent number of hydrogen atoms in the hydrocarbon).

The term “Periodic Table” refers to the version of the IUPAC Periodic Table of the Elements dated Jun. 22, 2007, and the numbering scheme for the Periodic Table Groups is as described in Chem. Eng. News, 63(5), 26-27 (1985). “Group 2” refers to IUPAC Group 2 elements, e.g., magnesium, (Mg), Calcium (Ca), Strontium (Sr), Barium (Ba) and combinations thereof in any of their elemental, compound, or ionic form. “Group 6” refers to IUPAC Group 6 elements, e.g., chromium (Cr), molybdenum (Mo), and tungsten (W). “Group 7” refers to IUPAC Group 7 elements, e.g., manganese (Mn), rhenium (Re) and combinations thereof in any of their elemental, compound, or ionic form. “Group 8” refers to IUPAC Group 8 elements, e.g., iron (Fe), ruthenium (Ru), osmium (Os) and combinations thereof in any of their elemental, compound, or ionic form. “Group 9” refers to IUPAC Group 9 elements, e.g., cobalt (Co), rhodium (Rh), iridium (Ir) and combinations thereof in any of their elemental, compound, or ionic form. “Group 10” refers to IUPAC Group 10 elements, e.g., nickel (Ni), palladium (Pd), platinum (Pt) and combinations thereof in any of their elemental, compound, or ionic form. “Group 14” refers to IUPAC Group 14 elements, e.g., germanium (Ge), tin (Sn), lead (Pb) and combinations thereof in any of their elemental, compound, or ionic form.

The term “support”, particularly as used in the term “catalyst support”, refers to conventional materials that are typically a solid with a high surface area, to which catalyst materials are affixed. Support materials may be inert or participate in the catalytic reactions, and may be porous or non-porous. Typical catalyst supports include various kinds of carbon, alumina, silica, and silica-alumina, e.g., amorphous silica aluminates, zeolites, alumina-boria, silica-alumina-magnesia, silica-alumina-titania and materials obtained by adding other zeolites and other complex oxides thereto.

“Molecular sieve” refers to a material having uniform pores of molecular dimensions within a framework structure, such that only certain molecules, depending on the type of molecular sieve, have access to the pore structure of the molecular sieve, while other molecules are excluded, e.g., due to molecular size and/or reactivity. The term “molecular sieve” and “zeolite” are synonymous and include (a) intermediate and (b) final or target molecular sieves and molecular sieves produced by (1) direct synthesis or (2) post-crystallization treatment (secondary modification). Secondary synthesis techniques allow for the synthesis of a target material from an intermediate material by heteroatom lattice substitution or other techniques. For example, an aluminosilicate can be synthesized from an intermediate borosilicate by post-crystallization heteroatom lattice substitution of the Al for B. Such techniques are known, for example as described in U.S. Pat. No. 6,790,433. Zeolites, crystalline aluminophosphates and crystalline silicoaluminophosphates are representative examples of molecular sieves.

In this disclosure, while compositions and methods or processes are often described in terms of “comprising” various components or steps, the compositions and methods may also “consist essentially of” or “consist of” the various components or steps, unless stated otherwise.

The terms “a,” “an,” and “the” are intended to include plural alternatives, e.g., at least one. For instance, the disclosure of “a transition metal” or “an alkali metal” is meant to encompass one, or mixtures or combinations of more than one, transition metal or alkali metal, unless otherwise specified.

All numerical values within the detailed description and the claims herein are modified by “about” or “approximately” the indicated value, and take into account experimental error and variations that would be expected by a person having ordinary skill in the art.

In one aspect, the present invention is a hydroisomerization catalyst, useful to make dewaxed products including base/lube oils, the catalyst comprising a base extrudate formed from an SSZ-91 molecular sieve and an alumina, wherein the alumina has a pore volume in the 11-20 nm pore diameter range of 0.05 to 1.0 cc/g and the base extrudate has a total pore volume in the 2-50 nm pore diameter range of 0.12 to 1.80 cc/g, and at least one modifier selected from Groups 6 to 10 and Group 14 of the Periodic Table.

In a further aspect, the present invention concerns a hydroisomerization process, useful to make dewaxed products including base oils, the process comprising contacting a hydrocarbon feed with a hydroisomerization catalyst under hydroisomerization conditions to produce a product or product stream; wherein, the hydroisomerization catalyst comprises a base extrudate formed from an SSZ-91 molecular sieve and an alumina, wherein the alumina has a pore volume in the 11-20 nm pore diameter range of 0.05 to 1.0 cc/g and the base extrudate has a total pore volume in the 2-50 nm pore diameter range of 0.12 to 1.80 cc/g, and at least one modifier selected from Groups 6 to 10 and Group 14 of the Periodic Table.

The SSZ-91 molecular sieve used in the hydroisomerization catalyst and process is described in, e.g., U.S. Pat. Nos. 9,802,830; 9,920,260; 10,618,816; and in WO2017/034823. The SSZ-91 molecular sieve generally comprises ZSM-48 type zeolite material, the molecular sieve having at least 70% polytype 6 of the total ZSM-48-type material; an EUO-type phase in an amount of between 0 and 3.5 percent by weight; and polycrystalline aggregate morphology comprising crystallites having an average aspect ratio of between 1 and 8. The silicon oxide to aluminum oxide mole ratio of the SSZ-91 molecular sieve may be in the range of 40 to 220 or 50 to 220 or 40 to 200. In some cases, the SSZ-91 material is composed of at least 90% polytype 6 of the total ZSM-48-type material present in the product. The polytype 6 structure has been given the framework code *MRE by the Structure Commission of the International Zeolite Association. The term “*MRE-type molecular sieve” and “EUO-type molecular sieve” includes all molecular sieves and their isotypes that have been assigned the International Zeolite Association framework, as described in the Atlas of Zeolite Framework Types, eds. Ch. Baerlocher, L. B. Mccusker and D. H. Olson, Elsevier, 6th revised edition, 2007 and the Database of Zeolite Structures on the International Zeolite Association's website (http://www.iza-online.org).

The foregoing noted patents provide additional details concerning SSZ-91 molecular sieves, methods for their preparation, and catalysts formed therefrom.

The alumina used in the hydroisomerization catalyst and process is generally referred to as a “high nanopore volume” alumina, abbreviated herein as “HNPV” alumina. The HNPV alumina may be conveniently characterized according to its pore volume within ranges of average pore diameters. The term “nanopore volume” abbreviated herein as “NPV” provides a convenient label to define pore volume ranges and values within those ranges for the alumina, e.g., NPV pore volumes in the 6-11 nm pore diameter range, 11-20 nm pore diameter range, and the 20-50 nm pore diameter range. In general, the alumina has a pore volume in the 11-20 nm pore diameter range of 0.05 to 1.0 cc/g, or, more particularly, a pore volume in the 11-20 nm pore diameter range of 0.07 to 0.85 cc/g, or a pore volume in the 11-20 nm pore diameter range of 0.09 to 0.7 cc/g. Independently, or in addition to the foregoing 11-20 nm ranges, the alumina may have a pore volume in the 6-11 nm pore diameter range of 0.05 to 1.0 cc/g, or a pore volume in the 6-11 nm pore diameter range of 0.06 to 0.8 cc/g, or a pore volume in the 6-11 nm pore diameter range of 0.07 to 0.6 cc/g. Independently, or in addition to the foregoing 6-11 nm and 11-20 nm ranges, the alumina may have a pore volume in the 20-50 nm pore diameter range of 0.05 to 1.0 cc/g, or a pore volume in the 20-50 nm pore diameter range of 0.07 to 0.8 cc/g or a pore volume in the 20-50 nm pore diameter range of 0.09 to 0.6 cc/g.

The alumina may also be characterized in terms of its total pore volume in a pore diameter range. For example, in addition to the foregoing NPV pore volumes, or separately and independently, the alumina may have a total pore volume in the 2-50 nm pore diameter range of 0.3 to 2.0 cc/g, or a total pore volume in the 2-50 nm pore diameter range of 0.5 to 1.75 cc/g, or a total pore volume in the 2-50 nm pore diameter range of 0.7 to 1.5 cc/g.

The catalyst comprising the base extrudate formed from the SSZ-91 sieve/HNPV alumina generally also comprises at least one modifier selected from Groups 6-10 and Group 14 of the Periodic Table (IUPAC). Suitable Group 6 modifiers include Group 6 elements, e.g., chromium (Cr), molybdenum (Mo), and tungsten (W) and combinations thereof in any of their elemental, compound, or ionic form. Suitable Group 7 modifiers include Group 7 elements, e.g., manganese (Mn), rhenium (Re) and combinations thereof in any of their elemental, compound, or ionic form. Suitable Group 8 modifiers include Group 8 elements, e.g., iron (Fe), ruthenium (Ru), osmium (Os) and combinations thereof in any of their elemental, compound, or ionic form. Suitable Group 9 modifiers include Group 9 elements, e.g., cobalt (Co), rhodium (Rh), iridium (Ir) and combinations thereof in any of their elemental, compound, or ionic form. Suitable Group 10 modifiers include Group 10 elements, e.g., nickel (Ni), palladium (Pd), platinum (Pt) and combinations thereof in any of their elemental, compound, or ionic form. Suitable Group 14 modifiers include Group 14 elements, e.g., germanium (Ge), tin (Sn), lead (Pb) and combinations thereof in any of their elemental, compound, or ionic form. In addition, optional Group 2 modifiers may be present, including Group 2 elements, e.g., magnesium, (Mg), Calcium (Ca), Strontium (Sr), Barium (Ba) and combinations thereof in any of their elemental, compound, or ionic form.

The modifier advantageously comprises one or more Group 10 metals. The Group 10 metal may be, e.g., platinum, palladium or a combination thereof. Platinum is a suitable Group 10 metal along with another Groups 6 to 10 and Group 14 metal in some aspects. While not limited thereto, the Groups 6 to 10 and Group 14 metal may be more narrowly selected from Pt, Pd, Ni, Re, Ru, Ir, Sn, or a combination thereof. In conjunction with Pt as a first metal in the catalyst, an optional second metal in the catalyst may also be more narrowly selected from the second Groups 6 to 10 and Group 14 metal is selected from Pd, Ni, Re, Ru, Ir, Sn, or a combination thereof. In a more specific instance, the catalyst may comprise Pt as a Group 10 metal in an amount of 0.01-5.0 wt. % or 0.01-2.0 wt. %, or 0.1-2.0 wt. %, more particularly 0.01-1.0 wt. % or 0.3-0.8 wt. %. An optional second metal selected from Pd, Ni, Re, Ru, Ir, Sn, or a combination thereof as a Group 6 to 10 and Group 14 metal may be present, in an amount of 0.01-5.0 wt. % or 0.01-2.0 wt. %, or 0.1-2.0 wt. %, more particularly 0.01-1.0 wt. % and 0.01-1.5 wt. %.

The metals content in the catalyst may be varied over useful ranges, e.g., the total modifying metals content for the catalyst may be 0.01-5.0 wt. % or 0.01-2.0 wt. %, or 0.1-2.0 wt. % (total catalyst weight basis). In some instances, the catalyst comprises 0.1-2.0 wt. % Pt as one of the modifying metals and 0.01-1.5 wt. % of a second metal selected from Groups 6 to 10 and Group 14, or 0.3-1.0 wt. % Pt and 0.03-1.0 wt. % second metal, or 0.3-1.0 wt. % Pt and 0.03-0.8 wt. % second metal. In some cases, the ratio of the first Group 10 metal to the optional second metal selected from Groups 6 to 10 and Group 14 may be in the range of 5:1 to 1:5, or 3:1 to 1:3, or 1:1 to 1:2, or 5:1 to 2:1, or 5:1 to 3:1, or 1:1 to 1:3, or 1:1 to 1:4.

The catalyst may further comprise an additional matrix material selected from alumina, silica, ceria, titania, tungsten oxide, zirconia, or a combination thereof. In more specific cases, the first catalyst comprises 0.01 to 5.0 wt. % of the modifying metal, 1 to 99 wt. % of the matrix material, and 0.1 to 99 wt. % of the SSZ-91 molecular sieve/HNPV alumina base extrudate. The catalyst may also be more narrowly described, e.g., the catalyst may comprise 0.01 to 5.0 wt. % of the modifier, 15 to 85 wt. % of the matrix material, and 15 to 85 wt. % of the SSZ-91 molecular sieve. More than one matrix material may be used, e.g., the matrix material may comprise about 15-65 wt. % of a first matrix material and about 15-65 wt. % of a second matrix material. In such cases, the first and second matrix materials generally differ in one or more features, such as the type of material or the pore volume and pore distribution characteristics. Where one or more matrix material is used, the first, second (and any other) matrix materials may also be the same type of matrix material, e.g., the matrix material may comprise one or more aluminas.

The catalyst base extrudate is also suitably characterized by pore volume, both in terms of total pore volume and the pore volume within certain average pore diameter ranges. As with the HNPV alumina, the base extrudate may be characterized according to pore volumes in the 6-11 nm pore diameter range, the 11-20 nm pore diameter range, and the 20-50 nm pore diameter range. In general, the base extrudate has a total pore volume in the 2-50 nm pore diameter range of 0.12 to 1.80 cc/g, or, more particularly, a total pore volume in the 2-50 nm pore diameter range of 0.20 to 1.65 cc/g, or a total pore volume in the 2-50 nm pore diameter range of 0.25 to 1.50 cc/g.

Independently, or in addition to the foregoing total pore volume 2-50 nm ranges, the base extrudate may have a pore volume in the 6-11 nm pore diameter range of 0.05 to 0.80 cc/g, or a pore volume in the 6-11 nm pore diameter range of 0.08 to 0.60 cc/g, or a pore volume in the 6-11 nm pore diameter range of 0.10 to 0.50 cc/g. Independently, or in addition to the foregoing 6-11 nm pore volume and 2-50 nm total pore volume ranges, the base extrudate may have a pore volume in the 11-20 nm pore diameter range of 0.05 to 0.80 cc/g, or a pore volume in the 11-20nm pore diameter range of 0.08 to 0.60 cc/g, or a pore volume in the 11-20 nm pore diameter range of 0.10 to 0.50 cc/g. Independently, or in addition to the foregoing 6-11 nm and 11-20 nm pore volume ranges, and 2-50 nm total pore volume ranges, the base extrudate may have a pore volume in the 20-50 nm pore diameter range of 0.02 to 0.35 cc/g, or a pore volume in the 20-50 nm pore diameter range of 0.03 to 0.30 cc/g, or a pore volume in the 20-50 nm pore diameter range of 0.05 to 0.25 cc/g.

The base extrudate may be made according to any suitable method. For example, the base extrudate may be conveniently made by mixing the components together and extruding the well mixed SSZ-91/HNPV alumina base material to form the base extrudate. The extrudate is next dried and calcined, followed by loading of any modifiers onto the base extrudate. Suitable impregnation techniques may be used to disperse the modifiers onto the base extrudate. The method of making the base extrudate is not intended to be particularly limited according to specific process conditions or techniques, however.

The hydrocarbon feed may generally be selected from a variety of base oil feedstocks, and advantageously comprises gas oil; vacuum gas oil; long residue; vacuum residue; atmospheric distillate; heavy fuel; oil; wax and paraffin; used oil; deasphalted residue or crude; charges resulting from thermal or catalytic conversion processes; shale oil; cycle oil; animal and vegetable derived fats, oils and waxes; petroleum and slack wax; or a combination thereof. The hydrocarbon feed may also comprise a feed hydrocarbon cut in the distillation range from 400-1300° F., or 500-1100° F., or 600-1050° F., and/or wherein the hydrocarbon feed has a KV100 (kinematic viscosity at 100° C.) range from about 3 to 30 cSt or about 3.5 to 15 cSt.

In some cases, the process may be used advantageously for a light or heavy neutral base oil feedstock, such as a vacuum gas oil (VGO), as the hydrocarbon feed where the SSZ-91/HNPV alumina catalyst includes a Pt modifying metal, or a combination of Pt with another modifier.

The product(s), or product streams, may be used to produce one or more base oil products, e.g., to produce multiple grades having a KV100 in the range of about 2 to 30 cSt. Such base oil products may, in some cases, have a pour point of not more than about −5° C., or −12° C., or −14° C.

The process and system may also be combined with additional process steps, or system components, e.g., the feedstock may be further subjected to hydrotreating conditions with a hydrotreating catalyst prior to contacting the hydrocarbon feed with the SSZ-91/HNPV alumina hydroisomerization catalyst, optionally, wherein the hydrotreating catalyst comprises a guard layer catalyst comprising a refractory inorganic oxide material containing about 0.1 to 1 wt. % Pt and about 0.2 to 1.5 wt. % Pd.

Among the advantages provided by the present process and catalyst system, are the improvement in yield of the base oil product produced using the inventive catalyst system comprising the SSZ-91 molecular sieve and HNPV alumina (hereinafter referred to as “SSZ-91/HNPV alumina” catalyst), as compared with the same process wherein a similar catalyst comprising SSZ-91 molecular sieve and alumina (hereinafter referred to as “SSZ-91/alumina” catalyst) is used that does not contain the HNPV alumina component having a pore volume in the 11-20 nm pore diameter range of 0.05 to 1.0 cc/g (or, in more specific cases, 0.07 to 0.85 cc/g, or 0.09 to 0.70 cc/g). In addition, in some cases, the base oil yield is notably increased by at least about 0.5 wt. % or 1.0 wt. %, when the inventive SSZ-91/HNPV alumina catalyst is used, as compared with the use, in the same process, of such a similar SSZ-91/alumina catalyst. The inventive SSZ-91/HNPV alumina catalyst and process also provides the added benefit of less fuels and gas production compared to the same similar SSZ-91/alumina catalyst.

In practice, hydrodewaxing is used primarily for reducing the pour point and/or for reducing the cloud point of the base oil by removing wax from the base oil. Typically, dewaxing uses a catalytic process for processing the wax, with the dewaxer feed is generally upgraded prior to dewaxing to increase the viscosity index, to decrease the aromatic and heteroatom content, and to reduce the amount of low boiling components in the dewaxer feed. Some dewaxing catalysts accomplish the wax conversion reactions by cracking the waxy molecules to lower molecular weight molecules. Other dewaxing processes may convert the wax contained in the hydrocarbon feed to the process by wax isomerization, to produce isomerized molecules that have a lower pour point than the non-isomerized molecular counterparts. As used herein, isomerization encompasses a hydroisomerization process, for using hydrogen in the isomerization of the wax molecules under catalytic hydroisomerization conditions.

Suitable hydrodewaxing conditions generally depend on the feed used, the catalyst used, desired yield, and the desired properties of the base oil. Typical conditions include a temperature of from 500° F. to 775° F. (260° C. to 413° C.); a pressure of from 15 psig to 3000 psig (0.10 MPa to 20.68 MPa gauge); a LHSV of from 0.25 hr⁻¹ to 20 hr⁻¹; and a hydrogen to feed ratio of from 2000 SCF/bbl to 30,000 SCF/bbl (356 to 5340 m³ H₂/m³ feed). Generally, hydrogen will be separated from the product and recycled to the isomerization zone. Generally, dewaxing processes of the present invention are performed in the presence of hydrogen. Typically, the hydrogen to hydrocarbon ratio may be in a range from about 2000 to about 10,000 standard cubic feet H₂ per barrel hydrocarbon, and usually from about 2500 to about 5000 standard cubic feet H₂ per barrel hydrocarbon. The above conditions may apply to the hydrotreating conditions of the hydrotreating zone as well as to the hydroisomerization conditions of the first and second catalyst. Suitable dewaxing conditions and processes are described in, e.g., U.S. Pat. Nos. 5,135,638; 5,282,958; and 7,282,134.

Suitable catalyst systems generally include a catalyst comprising an SSZ-91/HNPV alumina catalyst, arranged so that the feedstock contacts the SSZ-91/HNPV alumina catalyst prior to further hydrofinishing steps. The SSZ-91/HNPV alumina catalyst may be used by itself, in combination with other catalysts, and/or in a layered catalyst system. Additional treatment steps and catalysts may be included, e.g., as noted, hydrotreating catalyst(s)/steps, guard layers, and/or hydrofinishing catalyst(s)/steps.

### EXAMPLES

SSZ-91 was synthesized according to U.S. Pat. No. 10,618,816 and the aluminas were provided as Catapal® aluminas and Pural® aluminas from Sasol and Versal® aluminas from UOP. The SSZ-91 molecular sieve had a silica to alumina ratio (SAR) of 120 or below. The alumina properties used in the examples are shown in Table 1.

TABLE 1

| | Non-HNPV | HNPV | HNPV |
|---|---|---|---|
| Alumina | alumina | alumina I | alumina II |
| d10 (nm) | 3.8 | 4.5 | 8.9 |
| d50 (nm) | 6.7 | 7.6 | 19.1 |
| d90 (nm) | 9.6 | 21.1 | 23.9 |
| Peak Pore Diameter (nm) | 7.3 | 5.3 | 21.4 |
| Nanopore Volume (NPV) in | | | |
| the pore diameter range: | | | |
| 6 nm-11 nm (cc/g) | 0.33 | 0.45 | 0.12 |
| 11 nm-20 nm (cc/g) | 0.03 | 0.19 | 0.43 |
| 20 nm-50 nm (cc/g) | 0 | 0.12 | 0.45 |
| Total NPV (2-50 nm) (cc/g) | 0.55 | 1.1 | 1.04 |
| BET surface area (m²/g) | 296 | 367 | 218 |

### Example 1

### Hydroisomerization Catalyst A Preparation

A comparative hydroisomerization catalyst A was prepared as follows: crystallite SSZ-91 was composited with the conventional non-HNPV alumina of Table 1 to provide a mixture containing 65 wt. % SSZ-91 zeolite. The mixture was extruded, dried, and calcined, and the dried and calcined extrudate was impregnated with a solution containing platinum. The overall platinum loading was 0.6 wt. %.

### Example 2

### Hydroisomerization Catalyst B Preparation

Hydroisomerization catalyst B was prepared as described for Catalyst A to provide a mixture containing 65 wt. % SSZ-91 and 35 wt. % HNPV alumina I. The dried and calcined extrudate was impregnated with platinum to provide an overall platinum loading of 0.6 wt. %.

### Example 3

### Hydroisomerization Catalyst C Preparation

Comparative hydroisomerization catalyst C was prepared as described for Catalyst A to provide a mixture containing 45 wt. % SSZ-91 and 55 wt. % conventional non-HNPV alumina. The dried and calcined extrudate was impregnated with platinum to provide an overall platinum loading of 0.325 wt. %.

### Example 4

### Hydroisomerization Catalyst D Preparation

Hydroisomerization catalyst D was prepared as described for Catalyst A to provide a mixture containing 45 wt. % SSZ-91 and 55 wt. % HNPV alumina I. The dried and calcined extrudate was impregnated with platinum to provide an overall platinum loading of 0.325 wt. %.

### Example 5

### Hydroisomerization Catalyst E Preparation

Hydroisomerization catalyst E was prepared as described for Catalyst A to provide a mixture containing 45 wt. % SSZ-91, 20 wt. % HNPV alumina I and 35 wt. % HNPV alumina II. The dried and calcined extrudate was impregnated with platinum to provide an overall platinum loading of 0.325 wt. %.

Composition details for catalysts A to E are summarized in Table 2.

TABLE 2

| | Catalyst Composition (component Wt. %) | | | | |
|---|---|---|---|---|---|
| | Catalyst | Catalyst | Catalyst | Catalyst | Catalyst |
| Catalyst Component | A | B | C | D | E |
| Non-HNPV alumina | 35 | — | 55 | — | — |
| HNPV alumina I | — | 35 | — | 55 | 20 |
| HNPV alumina II | — | — | — | — | 35 |
| SSZ-91 | 65 | 65 | 45 | 45 | 45 |

Pore diameter, pore volume and catalyst surface area details for catalysts A to E are summarized in Table 3.

TABLE 3

| | Catalyst | | | | |
|---|---|---|---|---|---|
| Catalyst Property | Catalyst A | Catalyst B | Catalyst C | Catalyst D | Catalyst E |
| d10 (nm) | 3.4 | 4.9 | 4.9 | 6.6 | 5.3 |
| d50 (nm) | 6.3 | 14.7 | 9.7 | 14.6 | 11.4 |
| d90 (nm) | 13.9 | 24.6 | 13.5 | 19.0 | 26.4 |
| Peak Pore Diameter (nm) | 5.9 | 15.5 | 10.7 | 16.3 | 6.3 |
| Nanopore Volume (NPV) in | | | | | |
| the pore diameter range: | | | | | |
| 6 nm-11 nm (cc/g) | 0.13 | 0.08 | 0.28 | 0.13 | 0.23 |
| 11 nm-20 nm (cc/g) | 0.03 | 0.21 | 0.20 | 0.42 | 0.23 |
| 20 nm-50 nm (cc/g) | 0.02 | 0.10 | 0.01 | 0.04 | 0.14 |
| Total NPV (2-50 nm) (cc/g) | 0.33 | 0.45 | 0.6 | 0.65 | 0.72 |
| BET surface area (m²/g) | 266 | 226 | 271 | 233 | 264 |

### Example 6

### Hydroisomerization Performance for Catalysts A-B

Catalysts A and B were used to hydroisomerize a light neutral vacuum gas oil (VGO) hydrocrackate feedstock having the properties shown in Table 4.

TABLE 4

| VGO Feedstock Property | Value |
|---|---|
| gravity, °API | 34 |
| Sulfur content, wt. % | 6 |
| viscosity index at 100° C. (cSt) | 3.92 |
| viscosity index at 70° C. (cSt) | 7.31 |
| Wax content, wt. % | 12.9 |
| SIMDIST Distillation Temperature | |
| (wt. %), ° F. (° C.) | |
| 0.5 | 536 (280) |
| 5 | 639 (337) |
| 10 | 674 (357) |
| 30 | 735 (391) |
| 50 | 769 (409) |
| 70 | 801 (427) |
| 90 | 849 (454) |
| 95 | 871 (466) |
| 99.5 | 910 (488) |

The hydroisomerization reaction was performed in a micro unit equipped with two fixed bed reactors. The run was operated under 2100 psig total pressure. The feed was passed through the hydroisomerization reactor installed with one of catalysts A or B listed in Tables 2-3 at a liquid hourly space velocity (LHSV) of 2. The hydroisomerized product was then hydrofinished in the 2nd reactor loaded with a hydrofinishing catalyst to further improve the lube product quality (as described in U.S. Pat. No. 8,790,507B2). The hydrofinishing catalyst is composed of Pt, Pd and a support. The hydroisomerization reaction temperature was adjusted in the range of 580-680° F.

The hydrogen to oil ratio was about 3000 scfb. The lube product was separated from fuels through a distillation section. The lube oil product yield for comparative catalyst A based on a SSZ-91/non-HNPV alumina base extrudate and catalyst B formed from a SSZ-91/HNPV alumina base extrudate is shown in Table 5.

TABLE 5

| | Base Oil | Catalyst Activity | | |
|---|---|---|---|---|
| | Yield | Temp., | Viscosity | Gas Production |
| Catalyst | (wt. %) | CAT (° F.) | Index, VI | (wt. %) |
| Catalyst A | — | — | — | — |
| Catalyst B | +0.8 | +0 | +1 | −0.2 |

Compared to catalyst A having a non-HNPV base extrudate component, catalyst B having an HNPV base extrudate component demonstrated an increase of about 1 wt. % base oil/lube product. Catalyst B also generated less fuels and gas compared to non-HNPV comparative catalyst A.

The foregoing description of one or more embodiments of the invention is primarily for illustrative purposes, it being recognized that variations might be used which would still incorporate the essence of the invention. Reference should be made to the following claims in determining the scope of the invention.

For the purposes of U.S. patent practice, and in other patent offices where permitted, all patents and publications cited in the foregoing description of the invention are incorporated herein by reference to the extent that any information contained therein is consistent with and/or supplements the foregoing disclosure.

What is claimed is:

1. A hydroisomerization catalyst, useful to make dewaxed products including base oils, comprising
a base extrudate comprising an SSZ-91 molecular sieve and an alumina, wherein the alumina has a pore volume in the 11-20 nm pore diameter range of 0.05 to 1.0 cc/g and the base extrudate has a total pore volume in the 2-50 nm pore diameter range of 0.12 to 1.80 cc/g; and
at least one modifier selected from Groups 6 to 10 and Group 14 of the Periodic Table.

2. The catalyst of claim 1, wherein the modifier comprises a Group 8-10 metal of the Periodic Table.

3. The catalyst of claim 2, wherein the modifier is a Group 10 metal comprising Pt.

4. The catalyst of claim 1, wherein the alumina has a pore volume in the 6-11 nm pore diameter range of 0.05 to 1.0 cc/g, or a pore volume in the 6-11 nm pore diameter range of 0.06 to 0.8 cc/g, or a pore volume in the 6-11 nm pore diameter range of 0.07 to 0.6 cc/g.

5. The catalyst of claim 1, wherein the alumina has a pore volume in the 11-20 nm pore diameter range of 0.07 to 0.85 cc/g, or a pore volume in the 11-20 nm pore diameter range of 0.09 to 0.7 cc/g.

6. The catalyst of claim 1, wherein the alumina has a pore volume in the 20-50 nm pore diameter range of 0.05 to 1.0 cc/g, or a pore volume in the 20-50 nm pore diameter range of 0.07 to 0.8 cc/g or a pore volume in the 20-50 nm pore diameter range of 0.09 to 0.6 cc/g.

7. The catalyst of claim 1, wherein the alumina has a total pore volume in the 2-50 nm pore diameter range of 0.3 to 2.0 cc/g, or a total pore volume in the 2-50 nm pore diameter range of 0.5 to 1.75 cc/g, or a total pore volume in the 2-50 nm pore diameter range of 0.7 to 1.5 cc/g.

8. The catalyst of claim 1, wherein the base extrudate has a pore volume in the 6-11 nm pore diameter range of 0.05 to 0.80 cc/g, or a pore volume in the 6-11 nm pore diameter range of 0.08 to 0.60 cc/g, or a pore volume in the 6-11 nm pore diameter range of 0.10 to 0.50 cc/g.

9. The catalyst of claim 1, wherein the base extrudate has a pore volume in the 11-20 nm pore diameter range of 0.05 to 0.80 cc/g, or a pore volume in the 11-20nm pore diameter range of 0.08 to 0.60 cc/g, or a pore volume in the 11-20 nm pore diameter range of 0.10 to 0.50 cc/g.

10. The catalyst of claim 1, wherein the base extrudate has a pore volume in the 20-50 nm pore diameter range of 0.02 to 0.35 cc/g, or a pore volume in the 20-50 nm pore diameter range of 0.03 to 0.30 cc/g, or a pore volume in the 20-50 nm pore diameter range of 0.05 to 0.25 cc/g.

11. The catalyst of claims 1, wherein the base extrudate has a total pore volume in the 2-50 nm pore diameter range of 0.20 to 1.65 cc/g, or a total pore volume in the 2-50 nm pore diameter range of 0.25 to 1.50 cc/g.

12. The catalyst of claim 1, wherein the SSZ-91 molecular sieve comprises ZSM-48 type zeolite material, the molecular sieve having:
at least 70% polytype 6 of the total ZSM-48-type material;
an EUO-type phase in an amount of between 0 and 3.5 percent by weight; and
polycrystalline aggregate morphology comprising crystallites having an average aspect ratio of between 1 and 8.

13. The catalyst of claim 1, wherein the modifier content is 0.01-5.0 wt. % or 0.01-2.0 wt. %, or 0.1-2.0 wt. % (total catalyst weight basis).

14. The catalyst of claim 1, wherein the catalyst comprises Pt as a modifier in an amount of 0.01-1.0 wt. %, or 0.3-0.8 wt. % Pt.

15. The catalyst of claim 1, wherein the silicon oxide to aluminum oxide mole ratio of the molecular sieve is in the range of 40 to 220 or 50 to 220 or 40 to 200, or 50 to 140.

16. The catalyst of claim 1, wherein the SSZ-91 molecular sieve comprises one of more of:
at least 80%, or 90%, polytype 6 of the total ZSM-48-type material;
between 0.1 and 2 wt. % EU-1;
crystallites having an average aspect ratio of between 1 and 5, or between 1 and 3;
or a combination thereof.

17. The catalyst of claim 1, wherein the catalyst further comprises a matrix material selected from alumina, silica, ceria, titania, tungsten oxide, zirconia, or a combination thereof.

18. The catalyst of claim 17, wherein the catalyst comprises 0.01 to 5.0 wt. % of the modifier, 0 to 99 wt. % of the matrix material, and 0.1 to 99 wt. % of the SSZ-91 molecular sieve, or wherein the catalyst comprises 0.01 to 5.0 wt. % of the modifier, 15 to 85 wt. % of the matrix material, and 15 to 85 wt. % of the SSZ-91 molecular sieve.

19. The catalyst of claim 18, wherein the matrix material comprises 15 to 65 wt. % of a first matrix material and 15 to 65 wt. % of a second matrix material that differs from the first matrix material.

20. A process for producing a base oil product having an increased base oil product yield, the process comprising contacting a hydrocarbon feed with the hydroisomerization catalyst of claim 1 under hydroisomerization conditions to produce a base oil product.

21. The process of claim 20, wherein the hydrocarbon feed comprises gas oil; vacuum gas oil; long residue; vacuum residue; atmospheric distillate; heavy fuel; oil; wax and paraffin; used oil; deasphalted residue or crude; charges resulting from thermal or catalytic conversion processes; shale oil; cycle oil; animal and vegetable derived fats, oils and waxes; petroleum and slack wax; or a combination thereof.

22. The process of claim 20, wherein the base oil yield is increased using the catalyst of claim 1 as compared with the same process using a comparative hydroisomerization catalyst that differs only in that the alumina component does not have a pore volume in the 11-20 nm pore diameter range of 0.05 to 1.0 cc/g, or 0.07 to 0.85 cc/g, or 0.09 to 0.70 cc/g.
